(19) United States
(12) Patent Application Publication
(10) Pub. No.: US 2006/0162231 A1
(43) Pub. Date: Jul. 27, 2006

(54) Line and tackle securing device

(76) Inventor: Salvatore Massimino, Queensland (AU)

Correspondence Address: DENNISON, SCHULTZ, DOUGHERTY & MACDONALD, 1727 KING STREET, SUITE 105, ALEXANDRIA, VA, 22314, US

(21) Appl. No.: 10/528,467

(22) PCT Filed: Sep. 19, 2003
(86) PCT No.: PCT/AU03/01231

§ 371 Date: May 17, 2005

(30) Foreign Application Priority Data
Sep. 20, 2002 (AU) 2002951529

(51) Int. Cl. A01K 97/06

(52) U.S. Cl. 43/25.2

(57) ABSTRACT

A securing device for securing a line and/or fishing tackle to a fishing rod. the securing device comprising a body, a first aperture (11) in the body adapted to engage the fishing rod and a second aperture (12) in the body spaced from the first aperture (11) and adapted to releasably engage the fishing line and/or an item of fishing tackle. In further embodiment the device may be formed with holes to receive hooks, and being preferably buoyant and formed in bright colours. A method of securing a line is also described.

### FIELD OF THE INVENTION

This invention relates to a device and method for use with fishing rods. In particular, the invention relates to a device and method for securing a fishing leader and/or terminal tackle during storage or transport.

### BACKGROUND OF THE INVENTION

When ready for use, a fishing rod is typically rigged with a reel holding a spooled fishing line which is passed through a series of runners before being tied to items of terminal tackle such as sinkers, swivels, hooks and lures. A person who is fishing “rigs up” by assembling the reel on the rod and tying the terminal tackle in position in any preferred configuration.

If a fisherman elects to move position, he or she must decide whether to remove the terminal tackle while moving or, as commonly occurs, attempt to secure it to the rod. Methods such as attaching a hook to a runner and then tensioning the line while engaging a drag or ratchet mechanism in the reel are commonly used. Alternatively, the line may be wound around a feature of the reel, such as a handle, in an effort to secure its position. However, these methods have a number of deficiencies. When a line is tensioned by bowing of the rod it is common for a sinker to bounce as a person walks. The bouncing sinker may impact against the rod causing damage to an outer coating or alternatively may cause dislodging of the hook leading to a swinging pendulum effect of the terminal tackle presenting an obvious risk to a person holding the rod and to bystanders.

This problem is exaggerated in relation to the storage of rods on vehicles such as four wheel drive recreational vehicles. It is common for fishermen to use four wheel drive vehicles for accessing surf beaches, headlands and to travel to remote locations to access undisturbed waterways. Typically, a rod holding bracket will be mounted on the vehicle and particularly on accessories such as bull bars, with a recessed open cylinder adapted to receive an end of a fishing rod. The rod then extends backwards and over the roof of the vehicle to be in position when the vehicle moves either along a made road such as a highway, a track or on a beach. When fishing for highly mobile species such as salmon and tailor it is often necessary to change position frequently in order to locate and stay with a school of feeding fish. When a fisherman needs to enter the vehicle quickly and change position as well as exit and recommence fishing quickly, it is important to be able to retain a rigged up fishing rod which is easily accessible. When the terminal tackle is fixed purely by resilience of the hook it is, as noted above, possible for the hook to dislodge leading to a pendulum like effect in a sinker on the line. This presents an extra level of risk on vehicles as a heavy lead sinker may damage a vehicle outer body and even crack a windscreen or head light.

It would be advantageous to provide a device for securely temporarily restraining a fishing leader or line, particularly if such a device is easy to operate.

### SUMMARY OF THE INVENTION

Throughout this specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

In one form, although it need not be the only or indeed the broadest form, the invention resides in a securing device for securing a line and/or fishing tackle to a fishing rod, the securing device comprising:
a body;
a first aperture in the body adapted to engage a fishing rod; and
a second aperture in the body spaced from the first aperture and adapted to releasably engage a fishing line and/or an item of terminal tackle;
wherein the body is adapted to provide compression of the second aperture as a result of expansion of the first aperture.

The body may be formed with an upper surface, a lower surface and with a side wall intermediate the upper and lower surfaces. The upper and lower surfaces may be substantially planar. The side wall may be continuous. The body may be substantially cylindrical in shape. The lower surface may be recessed beneath a lower edge of the side wall. The apertures may be formed in appendages depending from the lower surface. Preferably the securing device has positive buoyancy.

The first aperture is preferably adapted to releasably engage the fishing rod. The first aperture may be formed as a first bore. The first bore may interconnect the upper and lower surfaces. Preferably, the first bore is slotted. The slotted bore may be defined by a wall formed from an invagination of the side wall. The bore may be substantially cylindrical and may be located adjacent an outer perimeter of the body, preferably adjacent the side wall. The slot may be adapted to provide access to the first bore for a shaft of the rod. The edges of the slot may be resiliently deformable.

A wall of the first bore may be formed substantially cylindrically. Alternatively, the wall may be configured as a transected cone. Other shapes may be suitable.

The second aperture may be spaced diametrically opposite the first aperture. Alternatively, the second aperture may be positioned elsewhere, but preferably adjacent the side wall. The second aperture may be formed as a second bore. The second bore may interconnect the upper and lower surfaces. The second aperture is preferably slotted with the slot dimensioned to permit passage of the fishing leader. A wall defining the second aperture may be configured substantially cylindrically. Preferably the wall defining the second aperture has a sloping side wall and may form a transected cone. The second aperture may include or form a seat. The seat may be adapted to receive a piece of terminal tackle, such as a sinker. The seat may be formed of a plurality of spaced ridges each separated from the next longitudinally along the bore. Alteratively or additionally, the seat may comprise one or more shoulders formed around the second bore.

In a preferred embodiment, the body is formed from a resiliently deformable material such as a polyvinyl chloride (PVC), polyethylene, polyurethane or other hard wearing material. Compression of the second aperture may include compression or narrowing of the second aperture slot. Expansion of the first aperture may include expansion or widening of the first aperture slot. The body may include a pivot zone to provide this function. The pivot zone may be formed by appropriate relative location of the first and second apertures.

In an alternative embodiment, the securing device may be formed with three or more apertures. At least two apertures may be adapted to receive different sized rods or sections of a rod. The body may be formed from material of a consistency for penetration by a fish hook and its retention until removed by force. The body may have one or more recesses or holes dimensioned to receive and hold a fish hook. The recesses or holes may be of varying sizes. The securing device may be of high visibility colour such as fluorescent yellow, blue or red.

In another aspect, the invention resides in a kit comprising two or more securing devices each formed for use on a rod of a different size to that of the other securing devices.

In a further aspect, the invention resides in a method of restraining a fishing leader or item of terminal tackle comprising the steps of:
placing a line securing device according to the above description on a fishing rod;
placing a terminal fishing leader and/or item of terminal tackle in the second aperture;
sliding the device in a direction of increasing rod shaft diameter and thereby compressing the aperture into restraining contact with the fishing leader and/or item of terminal tackle.

### BRIEF DESCRIPTION OF THE DRAWINGS

FIG. 1 is a top view of a securing device of the present invention.

FIG. 2 is a bottom view of the securing device of FIG. 1.

FIG. 3 is a perspective lower view of the securing device of FIG. 2.

FIG. 4 is a side view of the securing device of FIG. 2 taken in direction of arrow A of FIG. 2.

FIG. 5 is a side view of the securing device of FIG. 2 taken in direction of arrow B of FIG. 2.

FIG. 6 is a side view of the securing device of FIG. 3 taken in direction of arrow C of FIG. 2.

FIG. 7 is a perspective lower view of an alternative embodiment of a securing device.

FIG. 8 is a perspective lower view of a further alternative embodiment of a securing device.

FIG. 9 is a perspective lower view of another embodiment of a securing device.

FIG. 10 is a perspective top view of the securing device of FIG. 9.

FIG. 11 shows a securing device in use on a rod attached to a vehicle.

### DETAILED DESCRIPTION OF THE DRAWINGS

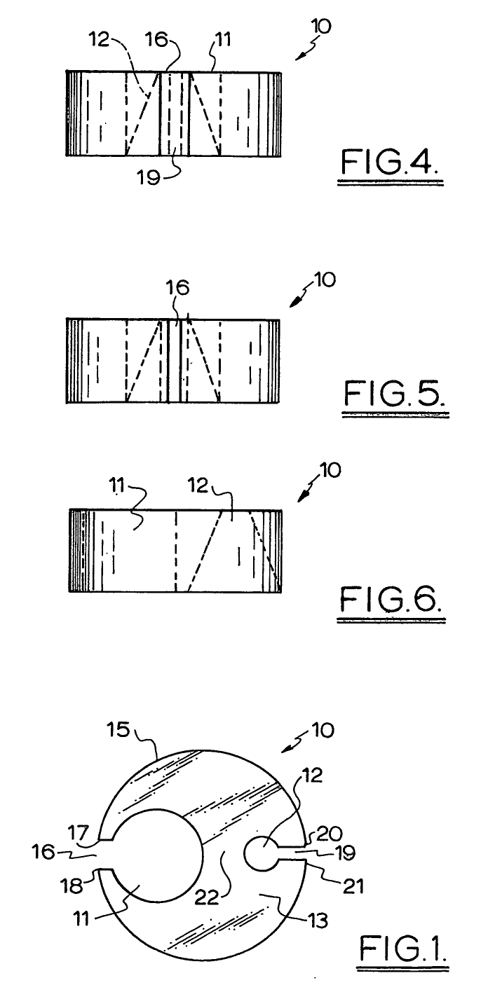

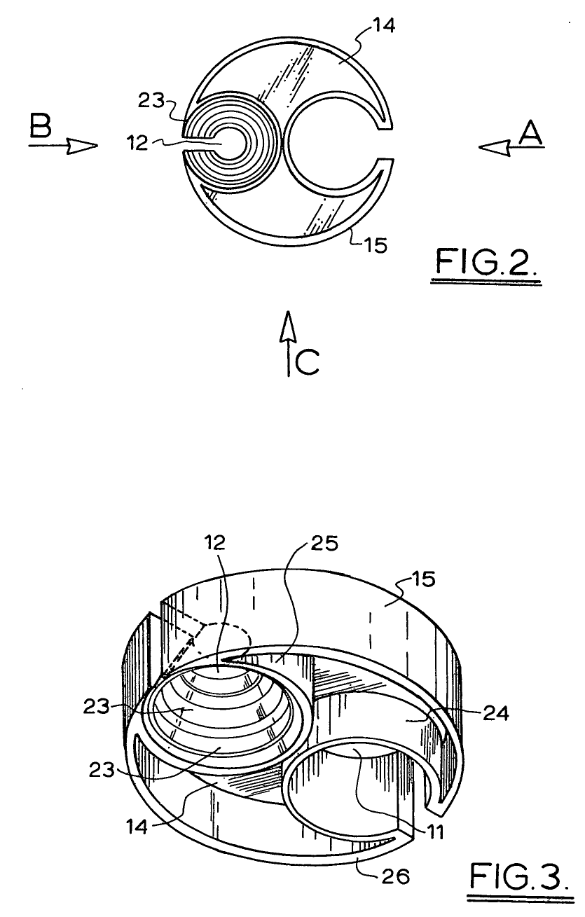

Referring to FIG. 1, there is seen a securing device for a fishing line and tackle 10 formed according to the present invention. The device 10 has a first aperture 11 and a second aperture 12. The first aperture 11 and second aperture 12 are both formed as bores which connect an upper surface 13 and lower surface 14 (seen in FIG. 2). The surfaces are substantially parallel and spaced, at least in part, by intermediate side wall 15.

The first aperture 11 is positioned adjacent an outer perimeter of the device 10 and communicates externally with the device 10 through first slot 16 which is defined by opposed jaws 17, 18. As seen, the first aperture is formed by an invagination of the outer wall 15.

The first aperture 11 is dimensioned to engage the shaft of a fishing rod. The jaws 17, 18 are preferably resiliently deformable so that the device 10 may be positioned on a shaft of the fishing rod by lateral force causing deflection of the jaws 17, 18 and positioning the shaft in the first aperture 11. The arrangement provides an easy procedure for mounting the device 10 on the fishing rod and also for removing it. It should be understood that a number of different arrangements will fulfil the same requirement. For example, a gate mechanism may be provided for entry into the first aperture 11. The gate mechanism may be in the form of a plurality of flexible fingers either overlapping or in proximity. In one embodiment, the first aperture may be closed and the device may be permanently mounted on the shaft of the fishing rod.

The second aperture 12 also communicates with the exterior of the device 10 through a second slot 19 which is defined by opposed jaws 20, 21. The second aperture is adapted to engage a fishing leader and/or a piece of terminal tackle such as a sinker or even a lure and may also be formed as an invagination of the side wall. In operation, the leader is passed through slot 19 and a sinker is located in aperture 12. The sinker may be forced into the aperture 12 which is formed as a truncated cone. In operation the upper surface 13 may be directed away from the ground or the butt of the rod so that downward pressure will assist in retaining a sinker in the aperture 12. It is clear that a variety of different configurations may be used for the second aperture. For example, it may be formed simply as a narrow slit into which a fishing leader is forced and thereby secured especially if then subject to compression and closure of the slit. Alternatively, it may be formed in a shape suitable to receive a fishing lure or other device.

In a preferred embodiment, the device 10 is formed from a resilient material such as polyethylene, polyurethane, or similar material. With such a construction, the location of the two apertures 11, 12 forms an internal bridge 22 which also forms a flexion zone for the device. This results in the function that expansion of the first aperture 11 with consequential increased separation of the jaws 17, 18 leads to a compression of the second aperture 12 and consequent narrowing of slot 19 due to approach of the adjacent jaws 20, 21.

In a method of operation, the first aperture 11 is located around a shaft of the fishing rod. An item such as a sinker is located in the aperture 12 and the device is then slid down the rod in a direction of increasing shaft diameter. As the shaft increases in size it wedges against the walls of the first aperture 11 and distends the aperture and slot 16 during advancement of the device. A consequent action is to cause the aperture 12 to compress and lock on to an item held within it. The sloping walls of the second aperture 12 provide a range of different diameters for receiving different size and shaped sinkers such as barrel sinkers, ball sinkers and snapper leads. Alternatively, the securing device may also be simply forced onto the rod, left in position and the terminal tackle or line pressed into engagement with the second aperture.

FIG. 2 shows a bottom view of the device of FIG. 1 and highlights the narrowing in of the wall of the first aperture 12 to provide a decreasing bore diameter. The wall is formed as a truncated cone and feature a series of shoulders 23 which sequentially decrease the diameter in step wise fashion with intervening wall sections still sloping. One advantage of the shoulders 23 is that they form a seat to receive a curved sinker such as a ball or barrel sinker. Different sized sinkers may also lodge in abutting contact with a different ridge or ridges.

The arrangement is apparent in FIG. 3 wherein the shoulders 23 are more readily apparent. The apertures 11, 12 are each formed in downwardly directed appendages 24, 25 respectively, which are formed from the lower surface 14 which is recessed from a lower edge 26 of wall 15. In another suitable embodiment the body is formed as a solid cylinder with apertures formed therein. The advantages of having the second wall recessed include decreased weight, less material required in manufacture and positive buoyancy.

FIG. 4 shows first slot 16 and outer limits of the first aperture 11 in hidden detail. The sloping nature of the second aperture 12 is apparent in hidden detail, as is the narrower nature of the second slot 19. FIG. 5 is a reverse view to that of FIG. 4.

In FIG. 6, the vertical wall of the first aperture 11 is apparent as is the slope of the wall of the second aperture 12. It would be possible to have sloping walls on the rod engaging first aperture and/or regular walls on the line/tackle engaging second aperture, if preferred.

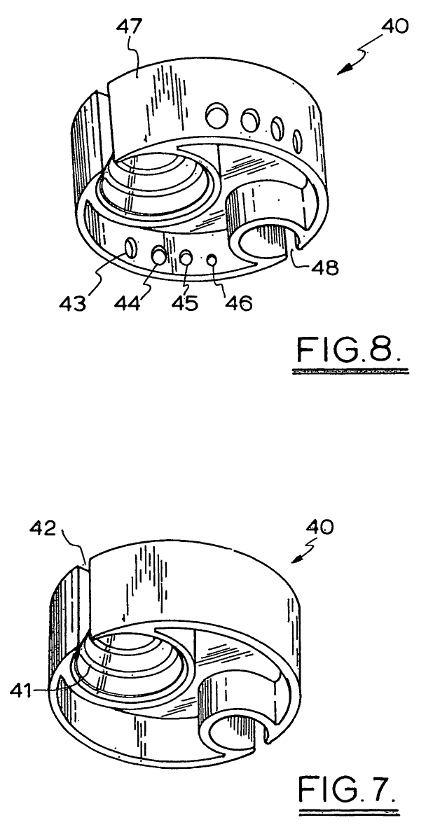

FIG. 7 shows another embodiment of a line securing device 40 in which shoulders 41 of a sinker engaging aperture 42 are more widely spaced and suitable for a larger sinker.

A variation of the embodiment of FIG. 7 is shown in FIG. 8 wherein recesses, or in this case, holes 43-46 are formed in the side wall 47. Those holes are dimensioned to receive fish hooks and are preferably of varying dimension.

In use, the rod engaging or first aperture 48 is pushed onto a rod shaft and then slid in the direction of increasing rod diameter. This occurs while or after a sinker is positioned in the second aperture 42. As the first aperture 48 is expanded, the second aperture 42 is compressed thereby leading to a gripping action on the sinker, It is also possible that the sinker may be simply forced into the aperture by a user, causing an outward deformation and subsequent rebound gripping of the sinker, while the first aperture simply engages the rod.

Once the sinker is secured, the hook may still be reasonably mobile if tied with a leader or trace of any significant length. The hook point may be located through one of the apertures 43-46 with the barb positioned to resist displacement.

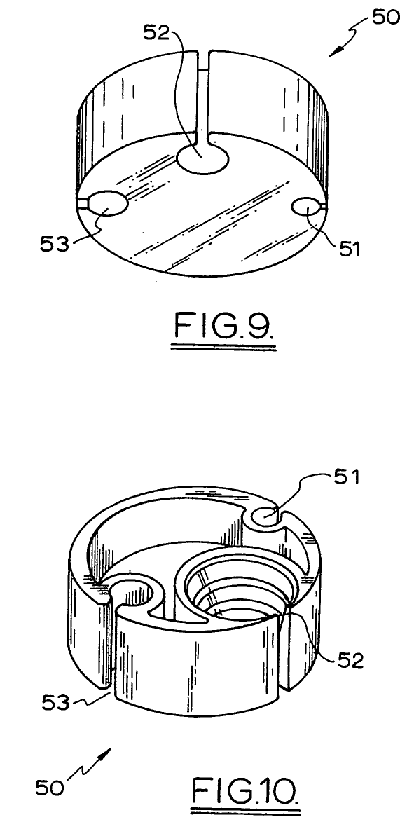

FIGS. 9 and 10 show yet a further embodiment especially suitable for use with fly rods.

The securing device 50 has three apertures, 51, 52, 53. The opposed apertures 51, 53 are designed to be located around a rod shaft. The slotted bores forming these apertures are of a relatively narrow diameter, one smaller than the other. This allows considerable utility in use with the finely tapered, narrow diameter fly rods. Either aperture may be used as appropriate to the rod shaft diameter. The tackle engaging aperture 52 is formed similarly to the previous description. This arrangement also shows the rod and tackle engaging apertures do not need to be diametrically opposed. Further, inversion of the views demonstrates that a user may choose to apply the device upside down.

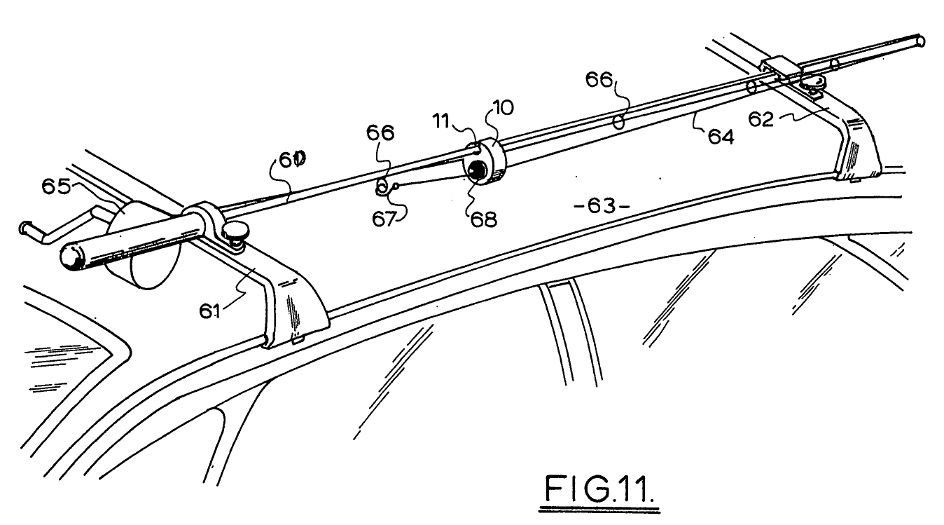

In FIG. 11, a fishing rod 60 is attached to carry bars 61, 62 on a vehicle 63. A line 64 runs from a reel 65, through runners 66 to a hook 67 positioned in one of the runners. A securing device 10 has a first aperture 11 positioned around the rod and sinker 68 positioned in the second aperture. Sliding the securing device 10 along the shaft of the rod 61 towards the reel 65 causes the grip on the sinker 68 to increase.

The present invention provides a distinct advantage to fishermen who wish to carry or store their fishing rod rigged. It provides equally significant advantages to fishermen who wish to transport their fishing rods in a rigged state either on a vehicle or in a vessel. The device adds increased safety to operation of a fishing rig as well as providing greater utility in operation. If a fisherman arrives at a site of high intensity fishing interaction such as when tailor are “on the bite”, he may grab his fishing rod already baited but certainly already rigged, release the leader, rotate the present device through 180 degrees to remove it from the field of fishing rod operation and cast, all within a matter of seconds. The securing device may be left attached to the rod. Alteratively, the securing device may be easily removed completely.

The device may include one or more additional apertures for receiving different shaped or sized sinkers or hooks thereby increasing its utility. The device may include one or more apertures for receiving the points or hooks to add additional security to restraint of a fishing leader by providing the initial restraint on an item such as a sinker and double securing device by locating a hook within an aperture. In some formulations, the material forming the device may be sufficiently soft for penetration of its outer surfaces by a hook point.

The line securing device may be formed in a range of sizes to engage different sized rod shafts. For example, a kit of securing devices may be provided sized, for example, to suit an estuary rod, a surf rod and a boat rod. Different sizes may be indicated by forming the devices in different colours, preferably highly visible colours such as fluorescent yellow, blue and red to indicate 3 different sizes.

Throughout the specification the aim has been to describe the preferred embodiments of the invention without limiting the invention to any one embodiment or specific collection of features. Those of skill in the art will therefore appreciate that, in light of the instant disclosure, various modifications and changes can be made in the particular embodiments exemplified without departing from the scope of the present invention. All such modifications and changes are intended to be included within the scope of the disclosure.

1. A securing device for securing a line and/or fishing tackle to a fishing rod, the securing device comprising:
a body;
a first aperture in the body adapted to engage a fishing rod and a second aperture in the body spaced from the first aperture and adapted to releasably engage a fishing line and/or an item of terminal tackle;
wherein the body is adapted to provide compression of the second aperture as a result of expansion of the first aperture.

2. The securing device of claim wherein the body is formed with an upper surface, a lower surface and a side wall continuous with the upper and lower surfaces.

3. The securing device of claim 2 wherein the body is substantially cylindrical in shape.

4. The securing device of claim 3 wherein the first aperture and second aperture are formed as invaginations of the side wall, the apertures providing through holes from the upper to the lower surface.

5. The securing device of claim 4 wherein the first aperture is adapted to releasably engage the fishing rod and is formed as a slotted bore.

6. The securing device of claim 5 wherein the bore is substantially cylindrical and is located adjacent an outer perimeter of the body.

7. The securing device of claim 6 wherein the edges of the slot are resiliently deformable to allow passage of a rod shaft into the aperture.

8. The securing device of any proceeding claim wherein the second aperture is spaced from and diametrically opposite the first aperture.

9. The securing device of claim 8 wherein the second aperture is formed as a second bore interconnecting the upper and lower surfaces.

10. The securing device of claim 9 wherein the second aperture is slotted with the slot dimensioned to permit passage of a fishing leader or line.

11. The securing device of claim 10 wherein the second aperture is configured substantially cylindrically.

12. The securing device of claim 10 wherein the wall defining the second aperture has sloping side walls substantially in the form of a transected cone.

13. The securing device of claim 12 wherein the second aperture includes a seat.

14. The securing device of claim 13 wherein the seat comprises a plurality of ridges.

15. The securing device of claim 13 wherein the seat comprises one or more shoulders formed in the wall of the second aperture.

16. The securing device of claim 1 wherein the body is formed from polyvinyl chloride, polyethylene or polyurethane.

17. The securing device of claim 1 further comprising three or more apertures, wherein at least two apertures are adapted to receive different sized rods or sections of a rod and one aperture is adapted to releasably engage a fishing line and/or an item of terminal tackle.

18. The securing device of any one of the preceding claims wherein the wall includes one or more recesses or holes dimensioned to receive the barb of a fish hook.

19. The securing device of any one of the preceding claims wherein the colour of the securing device is fluorescent yellow, blue or red or a combination thereof.

20. A kit comprising two or more securing devices formed according to claim 1, each of the two or more securing devices formed for use on a rod of a different size to that of each of the other securing devices.

21. A method of restraining a fishing leader or item of terminal tackle, said method comprising the steps of:
placing a first aperture of a line securing device in engagement with a fishing rod, placing a terminal fishing leader and/or item of terminal tackle in a second aperture of the line securing device and sliding the securing device in a direction of increasing rod shaft diameter to thereby compress the second aperture into restraining contact with the fishing leader and/or item of terminal tackle.
